(19) United States
(12) Patent Application Publication
(10) Pub. No.: US 2019/0002300 A1
(43) Pub. Date: Jan. 3, 2019

(54) METHOD FOR THE CONTROL OF SULPHATE FORMING COMPOUNDS IN THE PREPARATION OF POTASSIUM SULPHATE FROM POTASSIUM-CONTAINING ORES AT HIGH AMBIENT TEMPERATURES

(71) Applicant: Yara Dallol BV, HJ Sluiskil (NL)

(72) Inventors: Richard W. CHASTAIN, Montreal (CA); Ingrid T. BUCKHURST, Porsgrunn (NO); Antoine LEFAIVRE, Montreal (CA); Thomas H. NEUMAN, Montreal (CA)

(73) Assignee: Yara Dallol BV, HJ Sluiskil (NL)

(21) Appl. No.: 16/063,476

(22) PCT Filed: Dec. 21, 2016
(86) PCT No.: PCT/EP2016/082053

§ 371 Date: Jun. 18, 2018

(30) Foreign Application Priority Data
Dec. 22, 2015 (NO) 20151785

(51) Int. Cl. C01D 5/10; C01D 5/16

(52) U.S. Cl. CPC C01D 5/10; C01D 5/16

(57) ABSTRACT

There are provided methods for the production of potassium sulphate. The methods comprise contacting an aqueous potassium- and sulphate-containing composition with magnesium chloride (MgCl₂), thereby obtaining a composition comprising kainite; optionally concentrating the kainite from the composition; reacting the kainite with magnesium sulphate (MgSO₄) and potassium sulphate (K₂SO₄) so as to convert the kainite into leonite (K₂SO₄.MgSO₄.4H₂O); optionally contacting the leonite with water to remove excess MgSO₄ and contacting the leonite with water so as to leach the MgSO₄, contained in the leonite, and to at least substantially selectively precipitate potassium sulphate (K₂SO₄), and further involving a process brine sulphate control step, based on bloedite precipitation, to control the overall level of sulphate in the method. The method according to the invention can be operated at higher temperatures, in particular at temperatures above 35° C. and does not require a cooling step at 20 to 25° C. The method produces potassium sulphate with a low amount of chloride.

### TECHNICAL FIELD

The present disclosure relates to improvements in the field of methods for the preparation of potassium sulphate from potassium-containing ores, in particular to a method for the control of sulphate forming compounds therein.

### BACKGROUND OF THE DISCLOSURE

Potassium is the third major plant and crop nutrient after nitrogen and phosphorus. It has been used since antiquity as a soil fertilizer (about 90% of its current use). It is mined throughout the world from potassium deposits, either in under-ground or surface mines, wherein potassium is found in different chemical forms, such as carbonate, chloride, sulphate and nitrate. Each of these chemical forms requires a different chemical procedure to extract and concentrate the potassium from the deposits.

Since potassium sulphate (K₂SO₄) does not contain chloride, it is the preferred choice for crops which are sensitive to chloride, and which include coffee and several fruits and vegetables. Also crops that are less sensitive to chloride may still require potassium sulphate for optimal growth if the soil accumulates chloride from irrigation water.

Various methods have been proposed so far regarding the production of potassium sulphate (also called “sulphate of potash” or SOP) and various routes have been explored.

U.S. Pat. No. 2,902,344 (SINCAT SPA, 1959) discloses a process for the recovery of potassium sulphate from kainite ore (KCl.MgSO₄.H₂O) containing sodium chloride as an impurity. The kainite ore is converted into schoenite by mixing with the mother liquor containing some potassium sulphate at 20° C., and further decomposed into SOP using warm water, preferably at about 45° C.

U.S. Pat. No. 2,895,794 (International Minerals & Chemical Corporation, 1959) discloses a process for recovering potassium from kainite containing between about 5 and about 20 weight % of sodium chloride by converting it into leonite at a temperature between about 20 and 60° C.

FR 1.310.823 (SINCAT SPA, 1961) discloses a process for the production of leonite and/or K₂SO₄ starting from crude kainite, at temperatures where schoenite is stable in solution, i.e. between 20 and 40° C.

DE 1592035 A1 (SINCAT SPA, 1970) discloses a process for the recovery of potassium sulphate from kainite ore using a langbeinite (K₂Mg₂(SO₄)₃) suspension which is processed into schoenite (K₂SO₄. MgSO₄.6H₂O) and leonite (K₂SO₄.MgSO₄.4H₂O) at 20 to 35° C.

U.S. Pat. No. 3,058,806 (Metallgesellschaft, 1962) discloses a process for the production of SOP from kainite by the dissolution of kainite in hot water, which comprises a cooling step to form the schoenite crystals and reacting it with potassium chloride.

U.S. Pat. No. 3,589,871 (GREAT SALT LAKE MINERALS, 1971) discloses a method of producing kainite from natural brines containing potassium by adding MgCl₂ and using evaporation in solar ponds to precipitate kainite and carnallite (KMgCl₃. 6(H₂O)).

U.S. Pat. No. 3,634,041 (GREAT SALT LAKE MINERALS, 1972) discloses a process for the production of SOP from essentially pure schoenite.

WO 05/063626 A1 (Indian Council of Scientific Industrial Research, 2005) discloses a process for the production of SOP from bittern comprising a step wherein kainite is converted into schoenite, aqueous CaCl₂) is used and crude carnallite is produced as an intermediate using a cooling step at ambient temperature (25° C.).

None of the known processes is able to operate entirely at temperatures above 35° C., using a minimum of water as well as electrical power, and can be operated with different potassium deposits or a mixture thereof.

In this application, a method is disclosed which could be operated at higher temperatures, in particular at temperatures above 35° C. and which does not require a process step operated at a temperature below 35° C., in particular a cooling step at 20 to 25° C. Although the use of said method is not limited to said temperatures, the method according to the invention can be advantageously used in mining areas which are situated in warm or hot climates (such as the Dallol region in Ethiopia). Furthermore, the method of the invention is very energy-efficient as it does not use mechanical cooling, and it uses low amounts of freshwater. There-fore, the method according to the invention is especially suitable for use in remote location where access to energy and auxiliary systems is difficult. Furthermore, the method according to the invention may start from a solution, obtained by solution mining such that different potassium salts and mixtures thereof can be processed. It is a further object of the process to minimize water usage, as well as to minimize power usage and avoid the use of cooling water. The process can be operated economically in a hot, dry area that has limited resources available. The method is based on the finding that schoenite does not form at temperatures above 35° C., more in particular above 40° C. under the conditions of the described method, such that a method for the production of potassium sulphate was developed, based on the formation of leonite.

Furthermore, the method according to the present invention is based on the formation of bloedite to control the overall concentration of sulphate in the methods as described above.

### SUMMARY OF THE INVENTION

In a co-pending application, the inventors have provided, according to one aspect of the invention, a method for the production of potassium sulphate, comprising the steps of:

Ia) contacting an aqueous potassium- and sulphate-containing composition with magnesium chloride (MgCl₂), thereby obtaining a composition that, upon evaporation of the water, produces solids comprising kainite (KCl.MgSO₄.2.75 H₂O);

IIa) optionally, concentrating and separating the kainite from the composition, obtained in step Ia by flotation, thereby producing a rest composition (flotation tailings);

IIIa) reacting the kainite, obtained in step Ia or IIa, with water, optionally comprising magnesium sulphate (MgSO₄) and potassium sulphate (K₂SO₄), so as to convert the kainite into leonite (K₂SO₄.MgSO₄. 4H₂O) and separating the leonite thereof, thereby producing a rest composition (mother liquor); IVa) optionally, contacting the leonite, obtained in step IIIa, with water to remove remaining solid MgSO₄ compounds; and

Va) contacting the leonite, obtained in step IIIa or IVa, with water so as to dissolve leonite and/or leach the MgSO₄, contained in the leonite, and to at least substantially selectively crystallize potassium sulphate (K₂SO₄).

Furthermore, in a co-pending application, the inventors have provided, according to another aspect of the invention, a method for the production of potassium sulphate, comprising the steps of:

Ib) contacting an aqueous potassium and sulphate-containing composition, further comprising sodium chloride, with magnesium chloride (MgCl₂), thereby precipitating halite (NaCl) and obtaining a composition that, upon evaporation, produces solids comprising kainite (KCl.MgSO₄. 2.75H₂O);

IIb) optionally, concentrating and separating the kainite from the composition, obtained in step Ib and controlling the concentration of sodium chloride, present in the composition comprising kainite so as to maintain the concentration of sodium chloride below about 10% by weight on dry matter basis, thereby producing a rest composition (flotation tailings);

IIIb) reacting the kainite, obtained in step Ib or IIb with water, optionally comprising magnesium sulphate (MgSO₄) and potassium sulphate (K₂SO₄), at a temperature of about 35° C. to about 65° C. so as to convert the kainite into leonite (K₂SO₄.MgSO₄.4H₂O) and separating the leonite thereof, thereby producing a rest composition (mother liquor); and optionally at least minimizing formation of a solid solution comprising leonite and bloedite (Na₂Mg(SO₄).4H₂O) (i.e. the incorporation of sodium into the crystal structure of leonite), and/or schoenite (K₂SO₄.MgSO₄. 6H₂O);

IVb) optionally, contacting the leonite, obtained in step IIIb, with water to remove any remaining MgSO₄; and

Vb) contacting the leonite, obtained in step IIIb or IVb, with water so as to dissolve leonite and/or leach the MgSO₄, contained in the leonite, and to at least substantially selectively crystallize potassium sulphate (K₂SO₄).

Now, the inventors have developed a further method for the production of potassium sulphate, comprising a process brine magnesium sulphate control step, based on bloedite precipitation, thereby removing excess sulphate from the process. Hence, the invention relates to a method for the production of potassium sulphate, comprising the step of combining at least part of the balance composition (flotation tailings) from step IIa or IIb with at least part of the balance composition (mother liquor) from step IIIa or IIIb and optionally water, to precipitate bloedite.

The aforementioned step also recovers potassium from the flotation tailings: the kainite, left in the tailings, dissolves and is returned to the ponds to reprecipitate as kainite, while the bloedite precipitates and is filtered of with the rest of the tailings and discarded, in particular sent to waste storage.

Further features and advantages will become more readily apparent from the following description of various embodiments as illustrated by way of examples only and in a non-limitative manner.

### DETAILED DESCRIPTION OF THE INVENTION

The expression “by at least minimizing formation of bloedite” as used herein refers to a process in which the obtained product comprises a solid solution of leonite and bloedite, wherein the bloedite component is at a concentration of less than about 10% by weight of the total.

The expression “solid solution” refers to a solution which is said to exist in a crystal structure when a more or less complete substitution of one kind of atom, ion, or molecule for another that is chemically different but similar in size and shape occurs. As used here, it refers to a crystalline solid mixture containing a minor component uniformly distributed within the crystal lattice of the major component. An example is the solid solution of leonite and bloedite.

The expression “at least substantially selectively crystallize potassium sulphate (K₂SO₄)” as used herein, refers to a process in which the precipitated crystals comprises at least 85% by weight of potassium sulphate.

The expression “potassium- and sulphate-containing composition” means that the composition comprises potassium ions and sulphate ions, not necessarily from the same source, such as the same deposit, but also from different deposits and different potassium- and sulphate-containing ores.

Where weight % are cited, unless otherwise specified, such weight % are based on the weight of dry matter.

Step I

According to one aspect of the invention, there is provided a method for the production of potassium sulphate, comprising at least the step of contacting an aqueous potassium- and sulphate-containing composition with magnesium chloride (MgCl₂), thereby obtaining a composition that, upon evaporation, will produce solids comprising kainite (KCl.MgSO₄. 2.75 H₂O); the aqueous potassium- and sulphate-containing composition may additionally comprise an amount of sodium chloride (step Ib).

According to one aspect of the invention, in the methods of the present disclosure, the aqueous potassium- and sulphate-containing composition can be a brine comprising chlorides and sulphates of potassium, magnesium and sodium.

According to one aspect of the invention, the aqueous potassium- and sulphate-containing composition can be a solution mining brine. This offers the advantage that different types of potassium- and sulphate-containing ores can be processed into SOP by the same method according to the invention.

According to one aspect of the invention, the method according to the invention may comprise contacting one or more potassium- and sulphate-containing ores with water so as to obtain the aqueous potassium- and sulphate-containing composition, in particular the solution mining brine.

For example, the aqueous potassium- and sulphate-containing composition may comprise about 1 to about 100 g/l of K⁺ ion, about 5 to about 100 g/l of K⁺ ion, about 1 to about 50 g/l of K⁺ ion, about 5 to about 50 g/l of K⁺ ion, about 20 to about 100 g/l of K⁺ ion, about 40 to about 100 g/l of K⁺ ion, about 20 to about 50 g/l of K⁺ ion, or about 40 to about 50 g/l of K⁺ ion. Preferably, the aqueous potassium- and sulphate-containing composition may comprise about 42 g/l of K⁺ ion.

For example, the aqueous potassium- and sulphate-containing composition may comprise about 1 to about 150 g/l of SO₄²⁻ ion, about 10 to about 150 g/l of SO₄²⁻ ion, about 1 to about 100 g/l of SO₄²⁻ ion, about 10 to about 100 g/l of SO₄²⁻ ion, about 20 to about 150 g/l of SO₄²⁻ ion, about 40 to about 150 g/l of SO₄²⁻ ion, about 20 to about 100 g/l of SO₄²⁻ ion, or about 40 to about 100 g/l of SO₄²⁻ ion. Preferably, the aqueous potassium- and sulphate-containing composition may comprise about 67 g/l of SO₄²⁻ ion.

For example, the aqueous potassium- and sulphate-containing composition may comprise about 1 to about 100 g/l of Mg²⁺ ion, about 5 to about 100 g/l of Mg²⁺ ion, about 1 to about 50 g/l of Mg²⁺ ion, about 5 to about 50 g/l of Mg²⁺ ion, about 20 to about 100 g/l of Mg²⁺ ion, or about 20 to about 50 g/l of Mg²⁺ ion. Preferably, the aqueous potassium- and sulphate-containing composition may comprise about 22 g/l of Mg²⁺ ion.

For example, the above disclosed values for the ions K, SO₄²⁻, and Mg²⁺ ion are determined at a temperature of 45° C.

Step I further comprises an evaporation stage, resulting in crystallization and subsequent precipitation of solids comprising kainite. This stage may advantageously be carried out using solar evaporation ponds, in locations where ambient temperatures is 35° C. or more. Some methods disclosed in the prior art (see e.g. U.S. Pat. No. 3,589,871) involve the production of salts using solar pond evaporation but are based, at some point, on the conversion of said salts (hereafter called solar salts) to produce schoenite, with subsequent conversion to K₂SO₄. The use of solar ponds allows the evaporation of water and the formation of kainite such that kainite in solid form may be obtained.

Step II

According to one aspect of the invention, there is provided a method for the production of potassium sulphate, optionally comprising at least the step of concentrating the solid kainite from the composition, obtained in step Ia or Ib (step IIa or IIb).

The concentration step II may be necessary for removing impurities such as halite, preferably by flotation, from the kainite.

According to the method of the invention, the feed salt to the conversion (step IIIa) should have a very low halite content and a high kainite content, compared to prior art processes. According to one embodiment, this is preferably achieved by the use of evaporation ponds and by the use of pond chemistry control. Halite in the salts results in sodium ions in the conversion brine. This can lead to the formation of a solid solution of bloedite (Na₂Mg(SO₄).4H₂O) and leonite in which the produced leonite crystals contain sodium ions incorporated into the crystal (replacing potassium ions). This will result in leonite with a higher Mg to K ratio than pure leonite which in turn will decrease the efficiency of the SOP-crystallization (step V).

According to one aspect, the method further comprises controlling the concentration of the sodium chloride, present in the composition comprising kainite, so as to maintain the concentration of sodium chloride below about 10% by weight, preferably below about 5% by weight, more preferably below about 2.5% by weight, most preferably below 1% by weight on dry matter basis.

According to one aspect, controlling the concentration of sodium chloride, present in the composition comprising kainite, can be carried out by means of a flotation technique.

According to one aspect, the controlling of the concentration of sodium chloride present in the composition comprising kainite can be effective for obtaining a concentration of kainite of above 50% by weight, preferable above 60% by weight, more preferably above 70% by weight, and most preferably above 80% by weight, based on dry matter basis.

According to one embodiment, step II is omitted and the kainite composition from step I is sent directly to step III.

Step III

According to one aspect of the invention, there is provided a method for the production of potassium sulphate, comprising at least the step of reacting the kainite, obtained in step Ia or IIa, or step Ib or IIb, with water, optionally comprising magnesium sulphate (MgSO₄) and potassium sulphate (K₂SO₄), preferably at a temperature of about 35° C. or above, in particular of about 35° C. to about 65° C., so as to convert the kainite into leonite (K₂SO₄.MgSO₄. 4H₂O) and optionally at least minimize the formation of a solid solution comprising leonite and bloedite (Na₂Mg(SO₄). 4H₂O). According to one aspect of the invention, the water used for converting kainite into leonite may be part of a solution comprising water, potassium sulphate and magnesium sulphate. This will increase the recovery of potassium sulphate. According to one aspect of the invention, the mother liquor of the SOP crystallization, resulting from step V, may be the source of the water, MgSO₄, and K₂SO₄.

According to one aspect, the composition comprising kainite can be reacted with water at a temperature of about 35° C. or above, in particular of about 35° C. to about 70° C., more in particular of about 45° C. to about 70° C.

According to one aspect, leonite can be present in the composition comprising leonite at a concentration of at least 90% by weight, at least 95% by weight, or at least 99% by weight.

According to one aspect, the method can be carried out by at least substantially avoiding the formation of a solid solution comprising leonite and bloedite.

According to one aspect, the obtained solid solution comprising leonite and bloedite comprises less than about 5% by weight of bloedite, less than about 4% by weight of bloedite, less than about 3% by weight of bloedite, less than about 2% by weight of bloedite, less than about 1% by weight of bloedite, or less than about 0.5% by weight of bloedite.

Step IV

According to one aspect of the invention, there is provided a method for the production of potassium sulphate, optionally comprising at least the step of contacting the leonite, obtained in step IIIa or IIIb, with water to remove any remaining solid MgSO₄ compounds, in particular magnesium sulphate hydrates (leonite leach).

It was found that the recovery of potassium by crystallization of potassium sulphate was improved when solid magnesium sulphate hydrates, such as epsomite, hexahydrite, pentahydrite or starkeyite, were removed from the solids fed to the crystallizer.

According to one aspect of the invention, this step is most efficient (i.e. potassium losses are minimized) when a minimal amount of water is used such that the salt mixture produced from dissolving the solid MgSO₄ compounds is close to saturation with respect to those hydrates.

According to one aspect, removing remaining solid MgSO₄ compounds can be done by contacting the salt mixture comprising leonite and magnesium sulphate hydrate with an aqueous solution comprising magnesium sulphate and potassium sulphate, at a temperature of about 35° C. or above, in particular of about 40° C. to about 70° C., more in particular of about 45° C. to about 55° C.

According to one aspect, removing remaining solid magnesium sulphate compounds can be done by contacting the salt mixture comprising leonite and magnesium sulphate hydrate with the mother liquor of the SOP crystallization, resulting from step V.

According to one aspect, leonite can be present in the composition comprising leonite at a concentration of at least 90% by weight, at least 95% by weight, or at least 99% by weight.

According to one aspect, the method can be carried out by at least substantially avoiding the formation of a solid solution of leonite and bloedite.

According to one aspect, the obtained leonite comprises less than about 5% by weight of bloedite, less than about 4% by weight of bloedite, less than about 3% by weight of bloedite, less than about 2% by weight of bloedite, less than about 1% by weight of bloedite, or less than about 0.5% by weight of bloedite.

Step V

According to one aspect of the invention, there is provided a method for the production of potassium sulphate, comprising at least the step of contacting the leonite, obtained in step IV, with water so as to leach the MgSO₄ contained in the leonite and to at least substantially selectively solidify (i.e. crystallization and subsequent precipitation) potassium sulphate (K₂SO₄).

According to one aspect, the obtained potassium sulphate obtained can contain less than about 10% by weight of impurities, less than about 5% by weight of impurities, less than about 3% by weight of impurities, less than about 2% by weight of impurities, less than about 1% by weight of impurities, or less than about 0.5% by weight of impurities.

Preferably, the water needs to be provided at an elevated temperature, i.e. at a temperature of more than about 49° C., preferably of between 50° C. and 65° C., more preferably between 50° C. and 55° C. Such temperature can optionally be attained with the use of solar heating or by any other suitable means, i.e.; electrically using solar cells or by using tubes heated directly by the sun

For example, contacting the leonite with water so as to leach the MgSO₄ contained in the leonite and to at least substantially selectively crystallize and precipitate the potassium sulfate (K₂SO₄) can be effective for providing potassium sulfate that is crystallized and the method further comprises separating the crystallized potassium sulfate from a brine (mother liquor) by means of a solid-liquid separation, wherein the brine may comprise potassium sulphate and magnesium sulphate.

According to one aspect, the method can further comprise recycling said brine and using said brine for reacting with kainite, obtained in step IIa or IIb with the brine that comprises magnesium sulphate and potassium sulphate so as to convert the kainite into leonite, as disclosed in step IIIa or IIIb.

According to one aspect, the crystallization and subsequent precipitation of the potassium sulphate can be carried out at a temperature of about 45° C. to about 60° C., of about 48° C. to about 55° C., or of about 49° C. to about 53° C.

### Step VI: Process Brine Sulphate Control

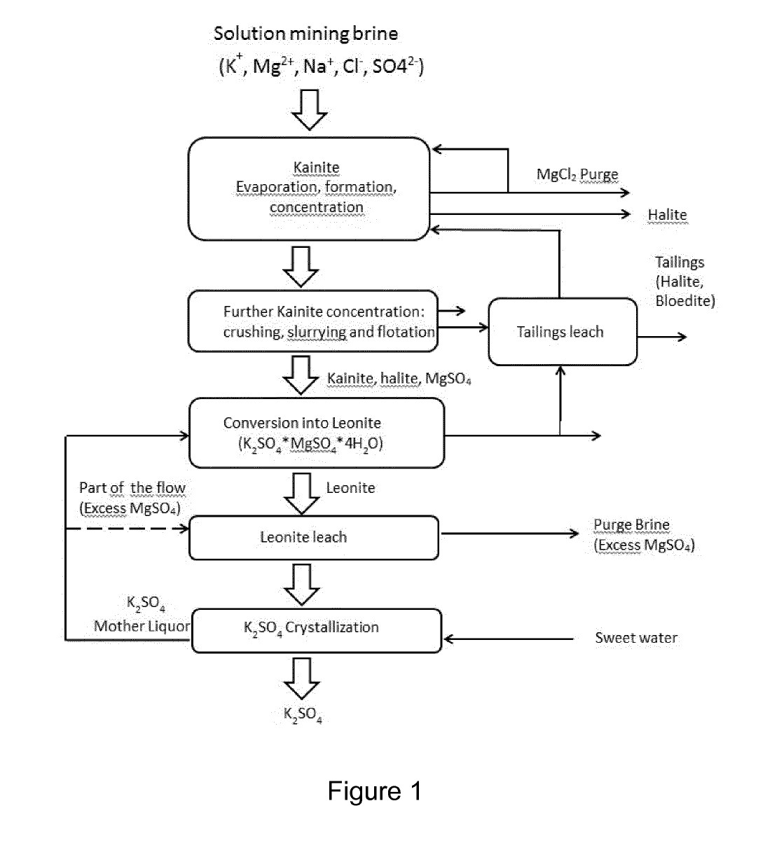

According to one aspect of the invention, there is provided a method for the production of potassium sulphate, comprising the step of combining the rest composition (flotation tailings) from step IIa or IIb with the rest composition (mother liquor) from step IIIa or IIIb and optionally water, to precipitate bloedite. By using a bloedite precipitation process step, the sulphate level in the entire process can be controlled. Also, this step recovers potassium from the flotation tailings. The step is preferably embodied in a so-called “tailings leach” step (see FIG. 1) that dissolves salts like kainite and magnesium sulphates in the slurry solution, leftover (balance composition) from the flotation in step IIa or step IIb, or leftover (balance composition) from the conversion of the kainite into leonite in step IVa or IVb. The step “Tailings leach” was originally designed, and can still be used, to dissolve any finely divided kainite in the filtrate from the flotation concentrate to prevent losing potassium from the process. According to the invention, by mixing in the mother liquor from the conversion reaction, excess sulphate is removed as bloedite solids which are precipitated and finally removed from the recycle brine stream tailings leach composition along with the remaining halite tails in a solid/liquid separation step, and may be discarded.

Surprisingly, it was established that, at a sufficient long retention time, a bloedite precipitation occurred during the tailings leach reaction in the brine, and it was recognized that this finding could be used to control the overall sulphate level in the method according to the invention. The kinetics tests indicated a relatively slow reaction; however, the reaction proceeded fast enough to go to completion in reasonably sized process equipment. Residence time can be controlled to provide an optimum concentration of sulfate ion remaining in the brine, which will be returned to the pond system. A typical residence time may be one hour. Because the reaction is not instantaneous, it allows an additional level of control. By varying the residence time of the reaction vessel (or partially bypassing the vessel, or other means to accomplish the same), the extent of the reaction can be controlled. This allows control of the sulfate level of the brine returned to the ponds, which in turn allows improved control of the chemistry in the ponds. For example, as sulfate concentrations are varied in the ponds, it is possible to precipitate magnesium sulfate hydrated salts at high sulfate levels, and carnallite at low levels in addition to halite and kainite. By controlling the extent of the bloedite precipitation, the ponds can be controlled so that precipitation of either magnesium sulfate hydrated salts or carnallite can be avoided, and only halite and kainite are produced. This removes any possible complicating factors associated with formation of carnalllite or magnesium sulfates in the pond system.

Optionally, the precipitation can be achieved using seeding with bloedite, e.g. small bloedite crystals. This becomes more important when less MgSO₄ is present in the process, such that less MgSO₄ is present in the tailings leach. With less MgSO₄ in the process, the process is more dependent on the bloedite seeding. At these conditions, without seeding, the risk exists that bloedite might supersaturate (i.e. it does not precipitate). Bloedite supersaturation is reduced with a higher MgSO₄ content in the tailings leach since this pushes the equation to precipitate bloedite. The seeding can be done initially (once), intermittently (several times), and/or continuously.

Incorporating the bloedite precipitation in the tailings leach reaction in the process has a positive domino effect on the other steps of the method. This is due to the fact that the brine from the tailings leach is recycled for potassium recovery to be mixed with the solution mining brine (step I), for example in the pond system. The net effect is that the brine that is mixed with the solution mining brine has a much lower sulfate concentration while containing more MgCl₂, than without the claimed tailings leach step. Advantageously, the precipitation of undesirable hydrated magnesium sulfate salts (such as hexahydrite) in the pond system is also reduced or eliminated, if desired. Furthermore, the fact that no magnesium sulfate salts are introduced into the method according to the invention would also completely eliminate the need for the leonite leach step (step IV). Also, in this new process, the tailings salts contain bloedite which provides a solid purge point in the process for excess sulfate according to the invention.

### DETAILED DESCRIPTION OF THE DRAWINGS

In the following drawings, which represent by way of example only, various embodiments of the disclosure:

FIG. 1 shows a block diagram of an example of a process according to the present invention

According to one aspect of the invention, the brines (or salt compositions) that can be used in the methods of the present disclosure can be either naturally occurring, as in lakes, springs, or subsurface brine deposits, or produced by actively solution-mining deeper, more consolidated deposits. The brine can be concentrated in solar evaporation ponds by evaporation and the composition of the brine, as it progresses through a series of ponds, can be controlled by the use of recycled brine from subsequent steps in the process so as to produce salts comprising kainite, halite (NaCl), optionally carnallite (KMgCl₃. 6(H₂O)) and hydrated magnesium sulphate salts, other than leonite or schoenite, such as MgSO₄. 6H₂O in the solar ponds. For example, by management of the amount of bloedite precipitated in the tailings leach step, the chemistry of the solar ponds can be controlled so that harvested salts will not contain carnallite or magnesium sulphate hydrated salts.

Solar salts from the harvest ponds comprising kainite and halite can have a kainite concentration above about 50% by weight, or above about 59% by weight. For example, the concentration of kainite can be increased by means of flotation and/or leaching with suitable brine, where the species to be rejected are halite and hydrated magnesium sulphate salts, such that concentrated salts are obtained. The rejected species are further led to a tailings leach stage, where they can be removed from the process, or recycled to the ponds, either as a liquid or as a solid.

The concentrated salts can have a kainite concentration of above 65% or 70% by weight, in particular 80% by weight, or more, and they can then be reacted (conversion) at a temperature above about 35° C., or of about 35° C. to about 65° C., with recycled brine from subsequent steps in the process (also called mother liquor) to convert the kainite into leonite. The use of this recycled brine (mother liquor), which can contain a significant concentration of potassium sulphate, results in more leonite being produced than the potassium ion in the kainite feed alone would permit. For example, depending on the temperature of the conversion, other MgSO₄ contaminants may be precipitated, as well as leonite, and the leonite resulting from this reaction, if necessary to achieve a purity which is suitable for a feed to a potassium sulphate crystallization circuit, may be leached with suitable brine (leonite leach) and subjected to known solid-liquid separation techniques. At temperatures above about 35° C. or above about 45° C., the formation of schoenite was not observed. The brine, resulting from the conversion (conversion brine) can be returned to the tailings leach.

The magnesium sulphate, contained in the leonite, can then be subjected to selective leaching with water (for example water added or added to water) and crystallization, for example, in a vessel or vessels designed to promote crystal growth, whereby substantially all of the magnesium sulphate and a portion of the potassium sulphate contained in the leonite are taken into solution (or leached), with the remaining portion of the potassium sulphate produced as crystalline material. This crystallization can be conducted at a temperature of about 45° C. to about 60° C. For example, and without wishing to be bound by such a theory, leonite can be dissolved substantially at the same time the K₂SO₄ crystallization occurs.

For example, clear brine from this step can be used in earlier steps of the process where additional leonite may be precipitated. For example, it can be used for reacting magnesium sulphate in the kainite conversion reaction step into leonite. The clear brine can have a magnesium to potassium weight ratio of about 0.4 to about 0.7 or of about 0.5 to about 0.6. Potassium sulphate, remaining in brine streams, eventually recycled to the solar evaporation ponds, can again be captured as solid kainite and recovered. The potassium sulphate solids can be withdrawn from the crystallization equipment and may or may not be leached with additional water before being subjected to known solid-liquid separation techniques, where they may or may not be washed with water.

The high purity potassium sulphate solids can then be dried, sized and either granulated to meet market specifications or sold as produced.

Brines containing ions of K, Mg, Na, Cl and SO₄₋ can be concentrated by solar evaporation and by the use of recycle brines caused to precipitate salts comprising kainite, halite, carnallite and one or more hydrated magnesium sulphate salt.

The methods of the present disclosure can be directed to the production of high purity potassium sulphate, encompassing a maximized recovery of potassium sulphate in the crystallization step, by a process including conversion of kainite to high purity leonite in a system operating at high ambient temperature (for example temperatures above about 35° C.; temperatures of about 35° C. to about 65° C.; or about 35° C. to about 55° C.). At temperatures of about 45° C., formation of schoenite was not observed.

When tests were conducted to confirm conversion of kainite, containing appreciable amounts of halite and magnesium sulphate hydrates, to leonite in reaction with brine from the potassium sulphate crystallization step at a temperature at or above about 45° C., the resulting leonite was contaminated with bloedite (Na₂Mg(SO₄).4H₂O) not removable by washing. It was subsequently discovered that this is related to a high concentration of sodium ions in solution which results in bloedite forming, not as a separate discrete species, but apparently as crystal lattice replacement within the leonite crystals (a solid solution of the two species). Without wishing to be bound by such a theory, this is likely the result of the similarity between leonite and bloedite crystal structure; they are analogs in that both are four water hydrates of a magnesium sulphate double salt, with very little difference in size between the potassium and sodium ions (1.33 and 0.96 Angstrom respectively). The inventors found that contamination of leonite with bloedite by this mechanism may be controlled by maintaining the concentration of sodium ion in the conversion reaction brine low, say, for example, below about 10% by weight, below about 4% by weight, below about 2% by weight, or below about 1.4% by weight, and controlling the degree of super saturation created in the reaction vessels.

Without wishing to be bound by such a theory, it is believed that this crystal lattice replacement phenomenon is analogous to the contamination of sodium carbonate decahydrate crystal by crystal lattice inclusions of sodium sulphate decahydrate, experienced by the inventors in previous work. For the sodium carbonate—sodium sulphate—water system, the degree of contamination is directly proportional to the concentration of sulphate ion in the mother liquor. There was also an apparent correlation observed with the degree of super saturation created in the crystallizer—higher super saturation level and more rapid crystal formation accompanied by more sulphate in the crystal lattice—although this was difficult to prove beyond question, as was an apparent correlation with temperature.

The presence of magnesium sulphate, not associated with the potassium sulphate ion, requires higher water to potassium sulphate ratio to dissolve all the magnesium sulphate contained in the leonite feed to the potassium sulphate crystallizer; this results in a higher percentage of the potassium sulphate contained in the leonite being taken into solution. Put in another way, the result is lower recovery of potassium as solid potassium sulphate and higher recycle brine flow because more water is used per unit of potassium sulphate produced, and larger evaporation ponds and plant are required for any given production capacity.

According to another aspect of the invention, the tailings leach can advantageously be used to control the sulphate level in the entire process as described above, through bloedite precipitation. This is due to the fact that the brine from the tailings leach tank is recycled to the ponds for potassium recovery. The net effect is that the brine that is returned to the pond system has a much lower (but controllable) sulfate concentration than without the innovative tailing leach step. In this new process, the tailings salts contain bloedite which provides a solid purge point in the process for excess sulfate. According to one embodiment, this could replace a liquid MgSO₄ purge (FIG. 1: “Purge brine”) that is situated in the leonite leach step (step IV), increasing overall potassium recovery in the process.

The bloedite precipitation (Step VI) has an impact on several steps of the process.

a) Step I

The largest impact from the tailings leach step according to the invention, is on the ponds area. The tailings leach brine returns to the pond system for further evaporation and K-recovery. The composition of said recycle stream is directly affected by the Tailings Leach reaction, and thus, brine compositions in the pond system are also affected. Without the bloedite precipitation step, this stream contained a high concentration of sulfate, which led to the precipitation of undesirable hydrated magnesium sulfate salts (such as hexahydrite) in the pond system. According to the invention, within a reasonable reaction time in the tailings leach step, the brine returned to the pond system will contain much less magnesium sulfate, while containing more MgCl₂. This will change the pond system chemistry to the point where no magnesium sulfate salts are expected to precipitate in the pond system. Incorporating the Tailings Leach step into the process according to the invention would thus reduce the total tons of material being harvested and transported to the plant. Furthermore, the fact that no magnesium sulfate salts are carried to the plant would completely eliminate the need for the leonite leach step (step IV).

Step II (Flotation)

The flotation operation of the wet process is also impacted by the tailings leach step according to the invention. Because the hydrated magnesium sulphate salts are no longer in the feed to the process step II, concerns about trying to keep them from floating with the kainite disappear. Optimization of the flotation circuit can focus entirely in getting rid of NaCl carried with the kainite. This should also improve the overall grade and recovery of the flotation concentrate produced in the process, which then is transferred to step III). Furthermore, the absence of MgSO₄ salts in the ponds salts removes one possible variation in the composition. Lower variability in the solids feed will simplify control of the flotation equipment. The main impact on the flotation cells is the lower tonnage of salts processed, as no magnesium sulphate hexahydrate is harvested. This is due to the fact that less salt is harvested.

Step III (Conversion)

The conversion circuit is not impacted by the Tailings Leach step according to the invention. The operation remains the same, and the equipment required should not change. However, since there is absolutely no MgSO₄ solids floating with kainite and being fed to the conversion reactors, the solids tonnage processed is lower.

Step IV (Leonite Leach)

As already indicated, the absence of MgSO₄ solids in the process feed makes this step obsolete. This represents a direct elimination of mechanical equipment. According to one embodiment, common equipment linked to the leonite leach which can be eliminated are: an agitated tank, a distributor, pan filters, brine tank, pumps and conveyor. This is the single largest impact of the tailings leach step according to the invention.

Step V (Crystallization)

The crystallization section of the process is not affected directly by the tailings leach step according to the invention. The same amount of leonite has to be processed in order to reach the target SOP production, and the same product purity will be reached. However, the lower MgSO₄ concentration in the brine, carried with the solid leonite to the crystallizer, is a benefit to the overall process. With the absence of MgSO₄ solids in the harvested salts is an associated lower MgSO₄ concentration in the process brines recycled through the process. This is particularly advantageous on the leonite being fed to the crystallizer, because all MgSO₄ coming into the crystallizer (whether from the solids or the brine) will lower the recovery of the crystallization circuit. The brine carried with the leonite out of the conversion reactors contains less MgSO₄ than without the claimed tailings leach step. This solids will be washed on the leonite pan filter, but a lower MgSO₄ content in the brine will still reduce the MgSO₄ fed to the crystallizer. Additionally, no pipeline to carry the MgSO₄ purge from the plant to the pond area is required, resulting in more capital cost savings.

### EXAMPLES

The following example illustrates the method according to the invention. Optimization was not performed but the gist of the invention is shown hereunder. All process steps are performed in the laboratory on a laboratory scale.

Step I was not performed. The salt mixture used in the laboratory testing was made in the laboratory. The kainite salt was produced from a laboratory brine, made from commercially available halite and magnesium sulphates.

All testing was done in a bench scale range of 1-8 kg. However, the numbers in the tables below are adjusted to reflect a starting solid of 100 kg to Step II (kainite concentration).

Step II: Concentrating Kainite and Removal of Halite

A salt mixture of 57 weight % kainite, 18 weight % halite, 22 weight % magnesium sulphate and 6 weight % bishofite (MgCl₂.6H₂O) was slurried in a flotation brine (composition: NaCl, KCl, MgCl₂, MgSO₄.7H₂O and water). A frother aid and a flotation aid was added and the frothy supernatant was collected, filtered to remove remaining brine and kept for further processing in Step III. The salt mixture was ground to a P₈₀ of about 350 microns). Flotation was carried out at 45° C. Recovery of K was 90%.

| | Salt in (from | Flotation Brine | Flotation concentrate |
|---|---|---|---|
| | Step II) | (slurry fraction) | (top fraction) |
| | 100 kg | 370 kg | 64 kg |
| K | 9.0% | 1.0% | 13% |
| Mg | 8.6% | 6.6% | 10% |
| S | 10.5% | 2.5% | 12% |
| Cl | 21.3% | 17.6% | 18% |
| Na | 6.8% | 1.8% | 2% |

All % based on weight.

Step III: Conversion of Kainite into Leonite

The process was performed in semi continuous mode to prevent problems with super-saturation and sudden precipitation. The solids from step II and SOP-mother liquor brine from step V (synthetically made) was added in increments to a starting brine having the composition for an continuous process. The process was maintained at 45° C. and the retention time was 1 hour. The slurry was filtered and the solids were kept for further processing in Step IV. Leonite was added to seed the precipitation.

| | | SOP-Mother | Starting | Starting | Leonite |
|---|---|---|---|---|---|
| | Salt in | liquor brine | Brine | Leonite | solids |
| | 64 kg | 170 kg | 177 kg | 62 kg | 180 kg |
| K | 13% | 5.7% | 1.9% | 19.7% | 18.7% |
| Mg | 10% | 3.5% | 5.5% | 6.9% | 7.5% |
| S | 12% | 6.9% | 4.5% | 17.2% | 16.7% |
| Cl | 18% | 0.1% | 10.4% | 0% | 2.9% |
| Na | 2% | 0.05% | 1.8% | 0.03% | 0.8% |

All % based on weight.

Step IV: Washing of Leonite

The solids from step III were reslurried in leach brine to dilute entrained brine from the conversion reactor for 60 min (leach brine=SOP-mother liquor almost saturated with MgSO₄, similar to purge brine). It was then filtered and washed with brine from SOP crystallizer (SOP-mother liquor). The filtered solids were kept for further processing in Step V.

| | | | |
|---|---|---|---|
| | | SOP mother | |
| Salt in | Leach brine | liquor brine | Leonite solids |

Kilogram

| | 180 kg | 440 kg | 127 kg | 163 kg |
|---|---|---|---|---|
| K | 18.7% | 2.8% | 5.7% | 20.2% |
| Mg | 7.5% | 5.3% | 3.5% | 6.9% |
| S | 16.7% | 8.3% | 6.9% | 18.4% |
| Cl | 2.9% | 0.1% | 0.1% | 0.1% |
| Na | 0.8% | 0.05% | 0.05% | 0.3% |

All % based on weight.

Step V: SOP Crystallization

This process was performed in a semi-continuous mode. The crystallizer was loaded with a starting brine made from 0.49 weight % of the water and 59 weight % of the solid (leonite). The remaining salts and water were added in increments, while clear liquid was removed to keep the amount constant. The procedure lasted approximately 6 hours. The slurry was then centrifuged and dried. The potassium sulphate produced had a K₂O content over 50%, and a Cl content below 1%, which reflects the standard grade of chlorine free potassium sulphate.

| | Leonite solids | Water | | Filtrate |
|---|---|---|---|---|
| | (total) | (total) | SOP solids | (SOP ML) |
| | 147 kg | 181 kg | 24 kg | 304 kg |
| K | 20.8% | | 41.9% | 6.0% |
| Mg | 7.0% | | 0.4% | 3.3% |
| S | 18.7% | | 17.5% | 7.0% |
| Cl | — | | — | 0% |
| Na | 0.2% | | 0.1% | 0% |

All % based on weight.

Overall recovery is about 48% for this laboratory scale experiment. Although the recovery is somewhat low, the method can be optimized to achieve recoveries of 60% and more.

While a description was made with particular reference to the specific embodiments, it will be understood that numerous modifications thereto will appear to those skilled in the art. The scope of the claims should not be limited by specific embodiments and examples provided in the present disclosure and accompanying drawings, but should be given the broadest interpretation consistent with the disclosure as a whole.

1. A method for the production of potassium sulphate comprising the steps of:
Ia) contacting an aqueous potassium- and sulphate-containing composition with magnesium chloride (MgCl₂), thereby obtaining a composition that, upon evaporation of the water, produces solids comprising kainite (KCl.MgSO₄.2.75H₂O);
IIa) optionally, concentrating and separating the kainite from the composition, obtained in step Ia by flotation, thereby producing a rest composition (flotation tailings);
IIIa) reacting the kainite, obtained in step Ia or IIa, with water, optionally comprising magnesium sulphate (MgSO₄) and potassium sulphate (K₂SO₄), so as to convert the kainite into leonite (K₂SO₄.MgSO₄.4H₂O) and separating the leonite thereof, thereby producing a rest composition (mother liquor);
IVa) optionally, contacting the leonite, obtained in step IIIa, with water to remove remaining solid MgSO₄ compounds; and
Va) contacting the leonite, obtained in step IIIa or IVa, with water so as to dissolve leonite and/or leach the MgSO₄, contained in the leonite, and to at least substantially selectively crystallize potassium sulphate (K₂SO₄);
characterized in that it contains a further step VIa of combining at least part of the balance composition (flotation tailings) from step IIa with at least part of the balance composition (mother liquor) from step IIIa and optionally water, to precipitate bloedite.

2. A method for the production of potassium sulphate, comprising the steps of:
Ib) contacting an aqueous potassium and sulphate-containing composition, further comprising sodium chloride, with magnesium chloride (MgCl₂), thereby precipitating halite (NaCl) and obtaining a composition that, upon evaporation, produces solids comprising kainite (KCl.MgSO₄.2.75H₂O);
IIb) optionally, concentrating and separating the kainite from the composition, obtained in step Ib) by flotation and controlling the concentration of sodium chloride, present in the composition comprising kainite so as to maintain the concentration of sodium chloride below about 10% by weight on dry matter basis, thereby producing a rest composition (flotation tailings);
IIIb) reacting the kainite, obtained in step Ib or IIb with water, optionally comprising magnesium sulphate (MgSO₄) and potassium sulphate (K₂SO₄), at a temperature of about 35° C. to about 70° C., so as to convert the kainite into leonite (K₂SO₄.MgSO₄. 4H₂O) and separating the leonite thereof, thereby producing a rest composition (mother liquor); and optionally at least minimizing formation of a solid solution comprising leonite and bloedite (Na₂Mg(SO₄).4H₂O), and/or schoenite (K₂SO₄. MgSO₄.6H₂O);
IVb) optionally, contacting the leonite, obtained in step IIIb, with water to remove any remaining solid MgSO₄ compounds; and
Vb) contacting the leonite, obtained in step IIIb or IVb, with water so as to dissolve leonite and/or leach the MgSO₄, contained in the leonite, and to at least substantially selectively crystallize potassium sulphate (K₂SO₄);
characterized in that it contains a further step VIb of combining at least part of the balance composition (flotation tailings) from step IIb with at least part of the balance composition (mother liquor) from step IIIb and optionally water, to precipitate bloedite.

3. The method of claim 1, wherein said aqueous potassium- and sulphate-containing composition is a solution mining brine.

4. The method of claim 3, wherein method comprises contacting one or more potash-containing ores with water so as to obtain said aqueous potassium- and sulphate-containing composition.

5. The method according to claim 1, wherein said aqueous potassium- and sulphate-containing composition comprises about 5 to about 100 g/l of K⁺ ion, more in particular about 20 to about 50 g/l of K⁺ ion.

6. The method according to claim 1, wherein said aqueous potassium- and sulphate-containing composition comprises about 10 to about 150 g/l of SO₄²⁻ ion, more in particular about 40 to about 100 g/l of SO₄²⁻ ion.

7. The method according to claim 1, wherein said aqueous potassium- and sulphate-containing composition comprises about 1 to about 100 g/l of Mg²⁺ ion, more in particular about 20 to about 50 g/l of Mg²⁺ ion.

8. The method according to claim 1, wherein contacting said aqueous potassium- and sulphate-containing composition with magnesium chloride is carried out by contacting said aqueous potassium- and sulphate-containing composition with an aqueous composition comprising said magnesium chloride.

9. The method according to claim 1, wherein said method comprises controlling the concentration of sodium chloride present in said composition comprising kainite so as to maintain said concentration of sodium chloride below about 10% by weight, preferably below about 5% by weight, more preferably below about 2.5% by weight, most preferably below 1% by weight on dry matter basis.

10. The method according to claim 9, wherein controlling the concentration of sodium chloride, present in said composition comprising kainite, is carried out by means of a flotation technique.

11. The method according to claim 9, wherein said controlling of said concentration of sodium chloride, present in said composition comprising kainite, is effective for obtaining a concentration of kainite of above 50% by weight, preferable above 60% by weight, more preferably above 70% by weight, and most preferably above 80% by weight, on dry matter basis.

12. The method according to claim 1, wherein said composition comprising kainite is reacted with water, optionally comprising magnesium sulphate and potassium sulphate, at a temperature of about 35° C. or above, in particular of about 35° C. to about 70° C., more in particular of about 45° C. to about 70° C.

13. The method according to claim 1, wherein said method is carried out by at least substantially avoiding the formation of a solid solution comprising leonite and bloedite.

14. The method according to claim 1, wherein said solid solution comprising leonite and bloedite comprises less than about 5% by weight of bloedite, preferably less than about 1% by weight of bloedite.

15. The method according to claim 1, wherein said crystallized potassium sulphate obtained contains less than about 10% by weight of impurities, less than about 5% by weight of impurities, preferably less than about 2% by weight of impurities, less than about 1% by weight of impurities, or less than about 0.5% by weight of impurities.

16. The method according to claim 1, wherein contacting said leonite with water so as to leach said MgSO₄ contained in said leonite and to at least substantially selectively precipitate said potassium sulfate (K₂SO₄) is effective for providing potassium sulfate that is crystallized and said method further comprises separating said crystallized potassium sulfate from a brine by means of a solid-liquid separation, wherein the brine may comprise potassium sulphate and magnesium sulphate.

17. The method according to claim 16, wherein said method further comprises recycling said brine and using said brine for reacting kainite with said brine that comprises magnesium sulphate and potassium sulphate to convert said kainite into leonite.

18. The method according to claim 1, wherein the crystallization and/or precipitation of said potassium sulphate is carried out at a temperature of about 45° C. to about 60° C., preferably about 48° C. to about 55° C.

19. The method according to claim 1, wherein the bloedite precipitation in the tailings leach is achieved using seeding, either initially, intermittently and/or continuously.

20. The method according to claim 1, wherein the bloedite precipitation in the tailings leach is used to control the overall sulphate level in the method according to claim 1.
